(19) United States
(12) Patent Application Publication
(10) Pub. No.: US 2009/0056475 A1
(43) Pub. Date: Mar. 5, 2009

(54) Seat belt comfort measuring system

(75) Inventor: Richard Grabowski, Lady Lake, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Takata Seat Belts, Inc.

(21) Appl. No.: 10/307,115

(22) Filed: Nov. 27, 2002

(51) Int. Cl. G01L 5/04

(52) U.S. Cl. 73/862.391

(57) ABSTRACT

A system for objective measurement of passenger comfort is provided for analysis of a wide variety of passenger safety restraint systems. Sensor arrays mounted on flexible panels are connected to a computer for data analysis. Sensor points in the panels are repetitively scanned by system software and raw data is stored for future use. A video display associated with the computer provides real time display of loadings on the sensor points. A powered form for use with the system is also disclosed.

### FIELD OF THE INVENTION

The present invention pertains to systems for objectively analyzing safety restraints and in particular to such systems providing a dynamic mapping loadings imposed on vehicular seat belts.

### BACKGROUND OF THE INVENTION

Seat belt systems are relied upon today as a principal mode of safety restraint in large numbers of vehicles and equipment to control forward excursions of the occupant in a frontal impact and to restrain the occupant within the vehicle or equipment. Typical vehicular seat belt restraint systems include a lap belt which passes across the occupant's pelvis, and a shoulder belt portion which diagonally crosses the occupant's upper torso, including the clavicle and sternum. Tension on the seat belt webbing is provided by a spring loaded retractor which enables the webbing to be stored on the retractor when the belt restraint system is not deployed. Although maintaining tension on seat belts is desirable from the view-point of protecting an occupant, belt tension can be annoying to the occupant during normal operation of the vehicle. Also, frictional forces in the seat belt system can be too high such as during belt extraction making it more difficult for the passenger to put the seat belt on than is desired.

Motor vehicle manufacturers have sought various “comfort” features to reduce or eliminate passenger annoyance or discomfort. A key feature of such comfort enhancing programs centers on identifying what constitutes passenger discomfort. Research and development programs which rely upon subjective standards for identifying passenger discomfort have proven to be inefficient, especially for manufacturers of a large number of vehicle models as well as manufacturers of restraint systems to be incorporated in different manufacturers' vehicles. Each variation in vehicle geometry, seating component and restraint system mounting sites invariably alters the path of the seat belt webbing, and in particular the path of shoulder belts, which have proven to be the source of one of the greatest comfort concerns to vehicular occupants and vehicle manufacturers alike.

An objective analyzation of seat belt comfort of the passenger in a vehicle involves a large number of variables not only in the vehicle which may be a truck, full sized passenger car, compact car, a coupe, etc. as well as the various seat belt systems used in these various vehicles which may include a dual retractor system, an integrated three point system or another system. Within each of these seat belt systems there are also a large number of variables which effect the comfort of the individual such as a change in the belt path and in the forces exerted by the belt on the passenger. For example, a number of seat belt systems use a guide loop which guides the belt across the shoulder and down along the chest of the passenger. The guide loops are made of various constructions and impart various friction loads into the system as well as having different height locations and angles at which the belt is presented to the passenger. Thus, the guide may change the belt path across the shoulder and the forces applied to and the locations of the forces being applied to the passenger. The vehicle geometry and seat belt systems used will change the load the pressure points or nuisance areas on the passenger's body, some of which are high on the shoulder or clavicle and others of which are on the lower sternum portion of the body. Within the seat belt system the loading of the belt on the body may also be along a belt edge which can be a nuisance or can be across a particular area of the shoulder which can also be quite annoying to passengers riding. Moreover, the passenger does not remain stationary while in a vehicle but moves or rocks back and forward and may feel particularly undue belt loads such as when playing the radio or reaching for some other devices within the vehicle.

Additionally, an analysis of a static condition may not be a complete analysis since the passenger is also subjected to changes due to dynamic loading or forces on the vehicle as it travels and it would be best if there could be an analysis of the comfort for the seat belt system on a vehicle in motion. For instance, tracking in a vehicle along s-curves or when the vehicle goes up and down over bumps changes the loading on the belts. Also, the suspension for the particular vehicle will also change the forces and the loadings on the belt and between the passenger's body as the vehicle accelerates, goes around curves, and over bumps in the road.

Accordingly, in the present environment, what happens all too frequently is that seat belt and retractor manufacturers are called on to supply add-on features to the components utilized in a seat belt system to address passenger comfort complaints. Tension reducers are one common add-on that attempt to improve passenger comfort but unfortunately also increase the overall cost of the seat belt restraint system. Also, different types of low friction materials are employed with the seat belt webbing and/or on the belt contacting surfaces of the guide loops increasing their costs accordingly. As is apparent, this type of ad-hoc approach to solving passenger comfort problems with particular seat belt systems and particular makes and models of cars is less than desirable, particularly from a cost standpoint.

Heretofore there has been no objective analyzation system that accurately predicts the comfort of the passenger in a seat belt system particularly both in the static and dynamic loading condition. There is a need for a force measuring and a bit mapping system to show the belt loading particular for various vehicle geometries and on the passenger as the vehicle travels over bumps, s-curves or the like. Also, there is a need for a system that will show the effect of making changes within the seat belt system when trying to lessen particular comfort problems by making changes in the seat belt system and in its connection to the vehicle.

### SUMMARY OF THE INVENTION

It is an object of the present invention to provide an objective comfort measuring system for passenger restraints, and in particular for vehicular seat belt systems. The illustrated embodiment provides a comfort measuring system for dynamically mapping loads imposed on passengers by safety restraint belts. Additionally, the illustrated embodiment provides a comfort measuring system which can be readily adapted to a wide range of vehicles having different, internal geometries and/or different seat belt system components.

Herein, the illustrated comfort measuring system is portable in that it can be used in a test stand or in a vehicle to measure dynamic loading from the shoulder seat belt to the chest area of a passenger.

A further aspect of the present invention is to provide a comfort measuring system which can be readily mounted and dismounted from a variety of different vehicles, without requiring substantial modification to those vehicles, for the purpose of carrying out comfort measuring analyses.

In one embodiment there is provided a seat belt measuring system for measuring loadings including contact area or pressure or force distribution imposed on a passenger restrained by a safety restraint belt, comprised of a form having an outer surface, representing a passenger's torso, including the passenger's clavicle and sternum, and a sensor system associated with the seat belt to measure force or pressure being applied by the seat belt to the chest area and shoulder area and to provide output signals representative thereof to an analyzer. The analyzer records and analyzes the signals to provide a visual output. Herein, the sensors and analyzer provide a real time display or loadings on the form by the seat belt. The display may include graphs of force versus time or pressure versus time. The visual display may also include dynamic mapping of the loading of the seat belt along different areas of the passenger's body, e.g., areas corresponding to a passengers clavicle, chest or sternum. It should be understood that instead of a form the portable measuring system may be sued with a live passenger for measuring the different comfort criteria, e.g. belt forces or contact area, such as between their torso (corresponding to the form) and the belt.

The illustrated comfort measuring system allows repositioning of various components of the seat belt system not only to match the configurations actually used in a vehicle, but also component repositioning to new or different positions in an attempt to alleviate heavy loading on the seated passenger. That is, the anchor points may be moved, different retractors may be used, the retractor spring forces may be changed, different guide loops (if used) may be changed, the angle of the presentation of the belt to the clavicle may be changed, the belt path across the passenger's chest may be rerouted, or the belt may be repositioned to lay more flat on the passenger's shoulder or chest. Different seat belts with different kinds of soft or harder edges may also be tested. The friction in the system may be analyzed and changed if desired. All of these factors can be utilized to provide a seat belt system that optimizes a passenger's comfort without the costs associated with comfort enhancing add-ons. The preferred system provides visual displays and readouts that dynamically show objective measurements that result from one or more changes to the seat belt system in order to improve the comfort of the passenger.

### BRIEF DESCRIPTION OF THE DRAWINGS

FIG. 1 is a perspective view of a measuring system according to principles of the present invention;

FIG. 2 shows a portion of FIG. 1, taken on an enlarged scale;

FIGS. 3-5 are side elevational views of the measuring system;

FIGS. 6-9 are perspective views of alternative measuring systems;

FIG. 10 is an exploded perspective view of a sensor system employed in the present invention;

FIG. 11 is an electrical schematic diagram of the sensor system, with associated circuitry;

FIG. 12 is a top plan view of a sensor system employed in the present invention;

FIG. 13 is a fragmentary top plan view showing alignment of a sensor panel aligned with the seat back;

FIG. 14 is a front elevational view of a seat and seat belt paths;

FIG. 15 is a side elevational view of a motorized form used in the present invention;

FIG. 16 is a side elevational view of an alternative motorized form;

FIG. 17 is a schematic diagram of various seat belt paths extending across the motorized form;

FIG. 18 shows a fragment of a shoulder belt and sensor arrays;

FIG. 19 shows a screen output mapping loads imposed on the sensors of FIG. 18;

FIG. 20 is a diagram of force over time;

FIGS. 21-23 show screen outputs with pressure mappings and force graphs for different test conditions; and

FIG. 24 shows an alternative sensor system.

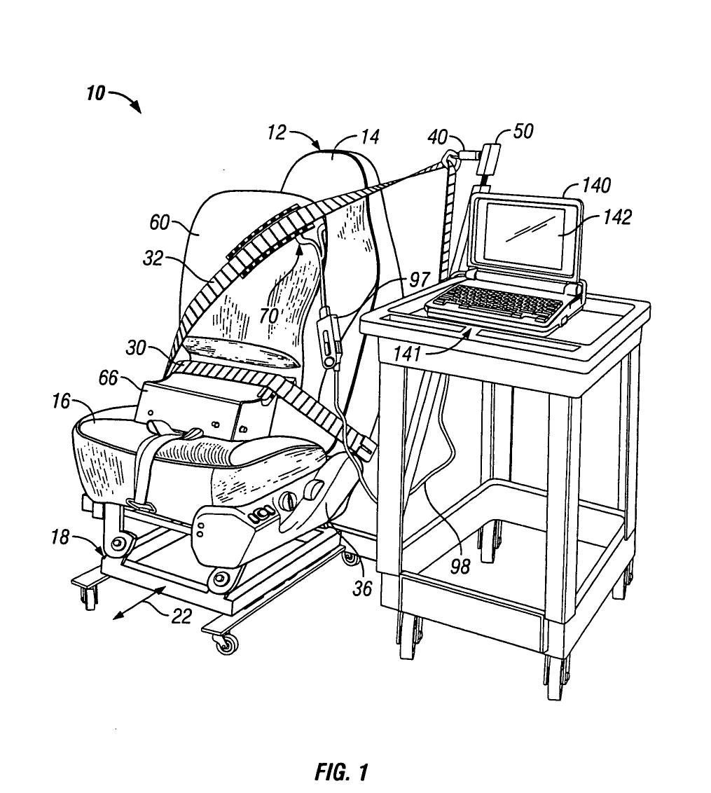

Referring now to the drawings, and initially to FIG. 1, a measuring system according to principles of the present invention is generally indicated at 10. The system measures loadings such as contact area, pressures and forces experienced by a passenger in a seat 12 having a seat back 14 and a seat bottom 16 supported by a structure generally indicated at 18. Structure 18 provides reciprocal mounting for the seat, allowing the seat to move back and forth in the direction of arrow 22. The seat 12 may be of a pivoting or tilting type, allowing the passenger to alter the angle between the seat back and seat bottom. Non-tilting seats, e.g., rear seats in a vehicle, could also be employed without modification to the measuring system.

System 10 has found immediate commercial application in providing an objective analysis of loadings experienced by passengers protected by belted restraint systems. More particularly, the present invention has been applied to automotive and truck vehicles, but the present invention could also be readily employed with other types of vehicles and equipment such as airplanes and test sleds, for example.

The present invention provides a number of important advantages to makers of vehicles, as well as makers of restraint systems. For example, test systems according to principles of the present invention can be readily employed in a wide variety of different vehicle interiors, different seats and safety restraint combinations. Measuring systems according to principles of the present invention can be temporarily installed in existing vehicular equipment, without requiring modifications to the equipment or causing perturbations which would alter observed results.

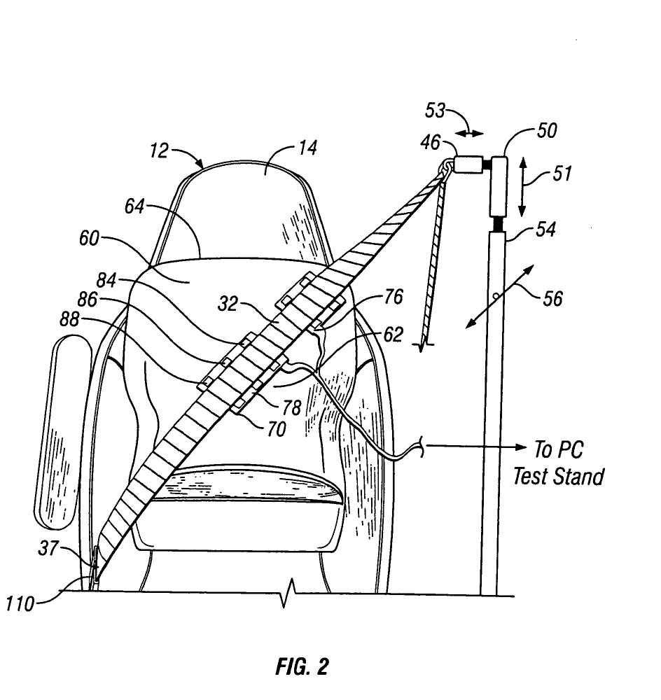

Even for a simple installation, if truly objective analyses are to be provided, the measuring system must successfully accommodate a range of varying test conditions. With reference to FIG. 1, a safety restraint system can include belt webbing having a lap belt portion 30 and a shoulder belt portion 32. The safety belts 30, 32 are preferably of commercial, unmodified design. As illustrated in FIGS. 1 and 2, lap belt portion 30 has one end connected to a conventional retractor 36 and the other end includes a conventional latch or tongue 37 for being inserted in an anchored buckle 110. Shoulder belt portion 32 is anchored at one end and extends up and is trained through a movable guide loop 40 located adjacent the seat back and then extends down across the passenger's or test dummy's torso to the latch plate.

The seat belt system illustrated in FIG. 1 is the integrated three point system and includes the guide loop 40 which may be of various constructions and have various friction forces imparted between the belt portion 32 extending across the shoulder and a portion 33 extending downwardly from the guideloop to a fixed anchored end. The positioning of the guide loop both in the forward and background direction, side-to-side direction and the vertical direction may be changed for a particular test as it relates to the actual conditions of where the guide loop will be positioned in the vehicle under consideration. Where the particular guide loop is positioned within the vehicle depends upon the vehicle and its attachment location, such as attachment to a B-pillar or the like. It should be appreciated that the position of the guide loop relative to the seat position and to the passenger's position determines the angle at which the belt extends to across the passenger's clavicle or chest and a repositioning of the guide loop may change the position of the belt path either to the left or right of the seat center line, as shown in FIG. 1. Manifestly, various turning loops may be provided and the various turning loops will have different friction characteristics. Also the angle at which the turning loop is mounted and its position can also be varied and the angle determines as illustrated in FIG. 1, the angle at which the belt meets the clavicle portion at the top apex of the shoulder of the seated person. Rather than attaching the belt to a turning loop, the shoulder belt may be attached directly to the stand 50 without a turning loop to replicate the attachment of the shoulder belt to a B-pillar directly.

Typically, the amount of seat belt withdrawn from the retractor at any time is some percentage of the total seat belt webbing available to be unreeled from the retractor, and the retractor springs exert retraction forces that are desired to be measured within this range of differing protracted belt lengths. For instance, with the belt fully retracted, there can be approximately 75% of the webbing spooled into the retractor, whereas with the typical maximum amount of webbing pulled out of the retractor, 75% of the webbing will be protracted from the retractor. And while the belt extraction and retraction forces should be close and change in parallel to each other as the amount of belt webbing extracted changes, it has been found that extraction forces go up with frictional forces in the seat belt system such as due to the guide loop, which can cause the retraction forces to go down even to the point where the belt will not stow properly. The present measuring system is well-suited to be able to identify and pin point these potential problems with the performance of the seat belt system and particularly the retraction/extraction forces thereof in the normal envelope or range of belt webbing lengths that are typically withdrawn from the retractor during operation of the seat belt restraint system.

As will be seen, test assemblies according to principles of the present invention can be used either in existing vehicles or in a laboratory test assembly in conjunction with a form 60 and vehicle seat components, such as that shown in FIG. 1. In the arrangement illustrated in FIG. 1, the test assembly is adapted for use in a laboratory environment, and is particularly useful for providing objective analysis of the same seat and safety restraint systems installed in a variety of different vehicles having varying interior dimensions and geometries. While the safety restraint systems tested may include the same safety restraint components (lap belt, shoulder belt, retractor and guide loop) the guide loop and perhaps the retractor(s) may be located in different positions with respect to the seat, and this would cause the passenger to experience different sensations in both static (e.g., parked vehicle) and dynamic (moving vehicle) conditions. With reference again to FIG. 1, for example, guide loop 40 may be moved to different locations with respect to seat 12 to replicate a particular vehicle of interest. The guide loop may be shifted left or right, up or down, front or back, from one vehicle model to another. Further and as previously mentioned, the guide loop may be eliminated and the belt may be anchored at the upper portion of the test stand as it would be attached to a B-pillar or the like where no guide loop is used in a particular vehicle being tested for seat belt comfort

To provide a practical emulation of different vehicle geometries, guide loop 40 is mounted on a stand 50 of the test assembly. Referring to FIG. 2, test stand 50 is movable in a vertical direction while the connection of guide loop 40 to test stand 50 is movable in a horizontal direction. Further, the base 54 is movable back and forth as indicated by arrow 56. It has been found that different guide loops produce different passenger sensations and accordingly test stand 50 is provided with a quick mounting feature to mount different guide loops 40 as may be required.

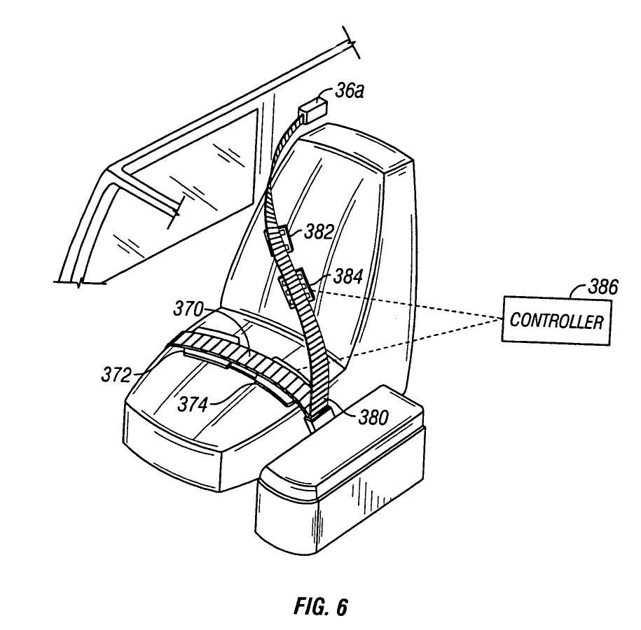

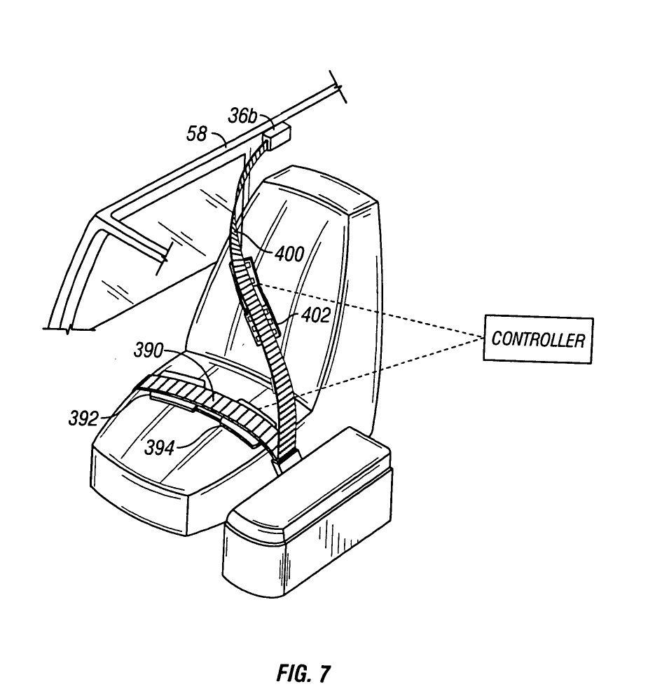

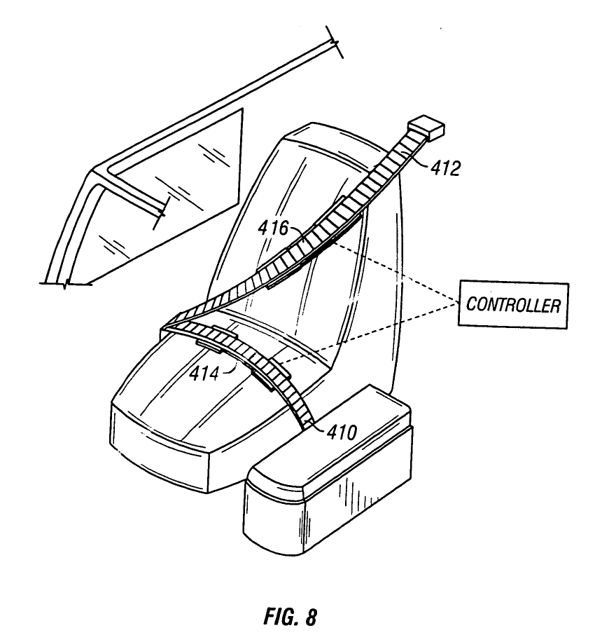

As best seen in FIG. 2, it is preferred that the test stand also allow movement of the upper portion 50 relative to the lower portion 54 to allow movement in the vertical direction 51 and as well as in the cross direction as shown by the arrow 56. In some instances particularly coupes or other configurations the shoulder belt may be positioned to exert greater pressure on the clavicle than does the illustrated belt configuration in FIGS. 1 and 2. The movement of the guide loop 40 to the left or right as indicated by the arrow 53 in FIG. 2 also results in a shifting of the seat belt relative to the center line of the vertical center line through the seat as well as the vertical center line through the passenger's sternum. Thus, the belt may be shifted inwardly or outwardly with respect to the outboard passenger's shoulder. Another seat belt system of the integrated three point type is shown in FIG. 6 in which a retractor 36a is disposed upwardly and mounted on a pillar at a stationary location above and to the rear of the seat as shown in FIG. 6. In the embodiment of the invention shown in FIG. 7 there is another three point system wherein the retractor 36b for the belt is mounted in an upper position for moving along a horizontal track 58. FIG. 8 still shows another embodiment of the seat belt system. As stated previously not only can the locations of the retractors be changed within a particular system such as a three point system for different vehicles, but there are also dual spring systems that have dual retractors that are mounted on different locations from that of the integrated three point system. Still, other systems may have an entirely different arrangement of components and attachment to the vehicle from those illustrated herein. For example, the retractors may be mounted on the seat themselves rather than on a B-pillar or other locations.

As will be explained hereinafter in greater detail, the preferred and illustrated method and apparatus for measuring comfort is portable in that it can be positioned about and within a seat of a moving vehicle traveling along a particular test ride or track with a dynamic mapping of the forces and pressures of the system on the passenger to provide a more accurate comfort mapping for the system in actual use and under varying conditions. For example, the measuring system may be placed in a vehicle and driven along a test track for 30 minutes while being subjected to bumps in the road and for moving along various curves and while experiencing accelerations and decelerations of the vehicle. The various vehicles each have their own particular characteristics when it comes to providing the forces being applied by the vehicle to the seat belt system and then to the passenger. By analysis of both the static as well as the dynamic testing, it is possible to provide an improved objective comfort measuring system for seat belt systems.

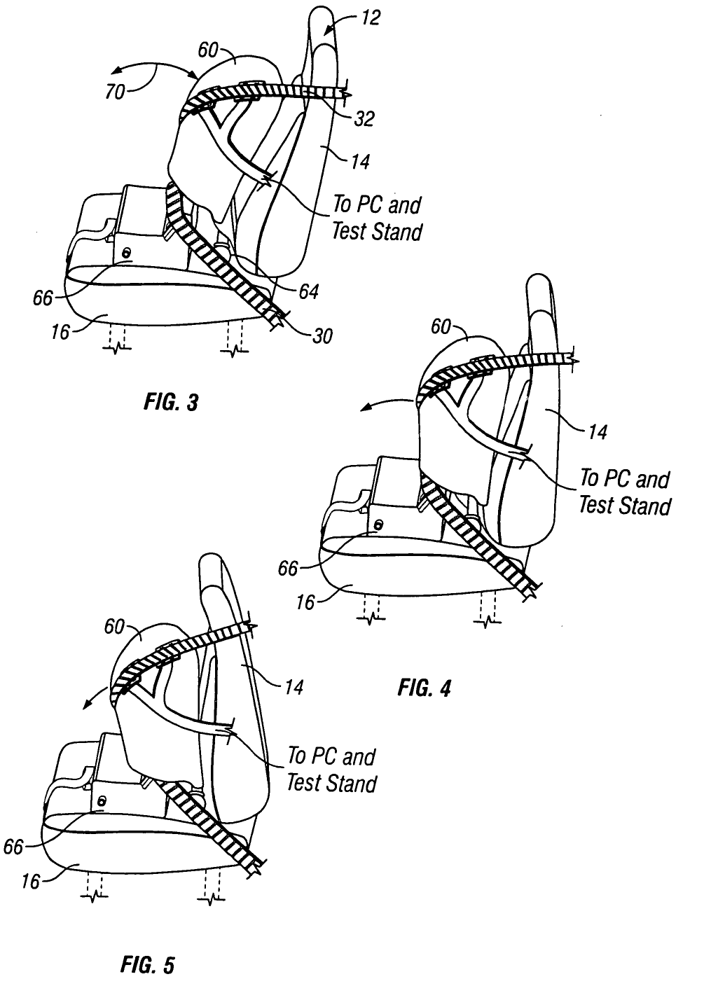

Referring again to FIG. 2, the measurement system can include an anthropomorphic form 60 used to emulate a passenger's torso such as one sized in the 50^{th} percentile of passengers and, including, for example, sternum and clavicle portions 62, 64, respectively. As seen for example in FIGS. 3-5, form 60 is continuously rounded throughout and does not include sharp angular features. It has been found that forms which include sharp-radiused or non-rounded features make objective, practical measurements difficult, and tend to distort observed results. Accordingly, form 60 is made to be continuously rounded, having rounded features throughout, that is, with features having radiused curves.

With reference to FIG. 3, form 60 is rotatably or pivotally supported at 64 to a test base 66, emulating a passenger's lap portion. If desired, form 60 could be freely pivotally mounted to base 66, but preferably form 60 is motor driven to pivot or rock front and back in the direction of arrow 70 of FIG. 3 such as by motor driven pivoting of the pivotal seat back 14 to which the torso form 60 can be secured. The motor-driven movement of form 60 emulates movement of a passenger reaching forward and leaning backward, and is preferably carried out in a smooth continuous cycle over a period of approximately one second or any other user-controlled duration as may be desirable. Preferably, the motor 60 is a variable speed motor to change the rate of oscillation of the seat back. Motor drive for form 60 could be supplemented with or replaced by a passive torsional damping system, depending upon the type of passenger emulation desired.

In FIGS. 3-5, the form 60 is shown in the various tilted positions, each of which causes a change in the shoulder belt sensations experienced by the passenger. In addition to changes resulting from a change of angle of the form, further sensation changes arise from movement of a passenger's torso (up, down, front, back, left, right) as well as vehicular forces transmitted to the seat, such as deceleration, acceleration, turns, uphill, and down hill travel, and bumps in the road.

Referring now to FIGS. 1, 2, 12 and 13, test system 10 includes a sensor arrangement generally indicated at 70. The sensor arrangement utilizes a film sensor system that includes one or more flexible, i.e., passenger conformal, matrix-based sensor panels. FIG. 2 shows the preferred split-sensor arrangement of two panels whereas FIG. 24 shows an arrangement of a single panel 500 having a greater number of sensor arrays 502. Preferably, the sensor panels comprise a conformal array of pressure sensitive tactile pressure sensors. In the most preferred embodiment, the sensor array comprises sensors including two sets of intersecting electrodes applied to respective backing sheets that are placed face-to-face with a layer of pressure sensitive variable resistance material therebetween. The variable resistance pressure sensors are arranged in arrays of desired shape, size, sensor density, pressure range and pressure sensitivity.

With reference to FIG. 11, a fragmentary portion of a sensor array is schematically indicated with four sensor panel inputs 160-166 and four sensor panel outputs 170-176. The resulting 16 sensor points 180 are schematically indicated as variable resistors, consistent with the description of the sensor construction, given above. Output from the sensor points is preferably detected at the sensor panel outputs, but may be sent to an additional set of outputs, not shown. Control circuit 190 determines which output signal is monitored at a given time. In practice, all outputs are sequentially scanned at a relatively high frequency, using drive ports coupled to the sensor panel inputs, under control of computer analyzer 140. As illustrated in FIG. 11, output 172 is being monitored. The outputs are converted into digital format at 194 and are sent downstream to connector 97. Although variable resistance sensors are preferred and have been described herein, it should be recognized that any type of sensor could be employed that has a low profile construction to enable it to be inserted in the area between the belt and a passenger's torso. For example, sensors using Hall Effect devices, variable capacitance devices or other conventional technologies could conceivably be used.

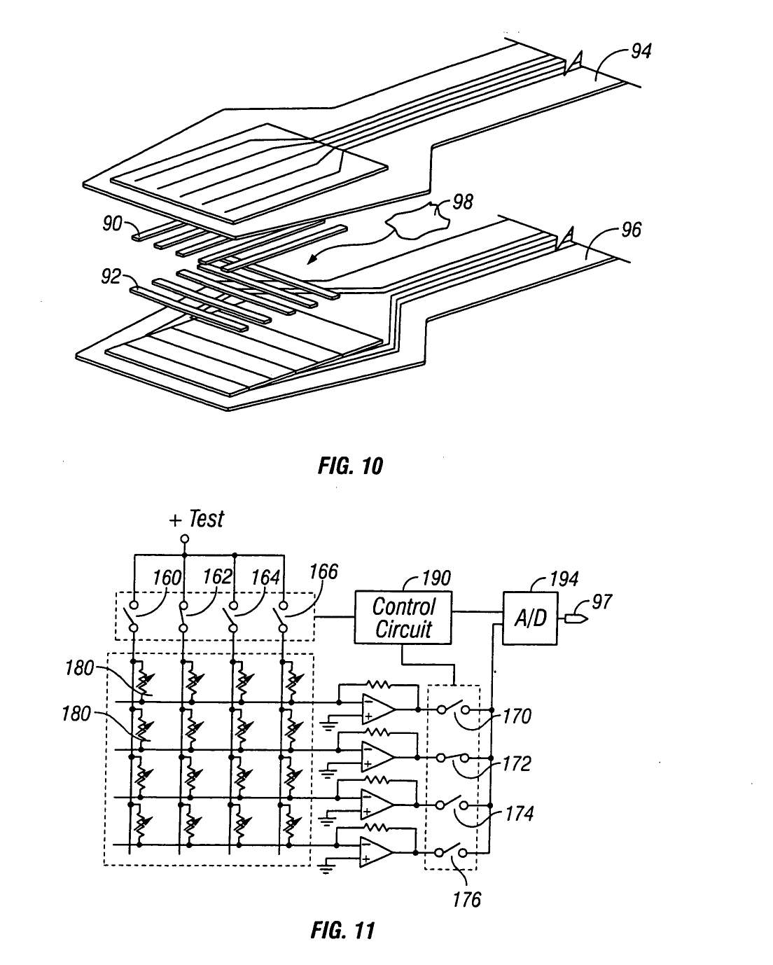

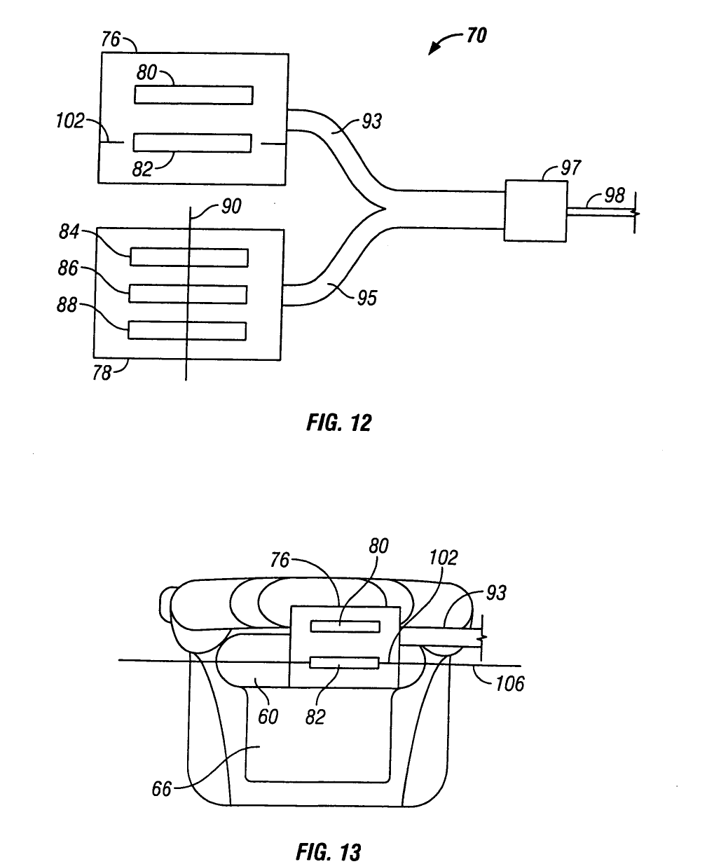

As shown for example in FIG. 12, two sensor panels 76, 78 are employed to great advantage to allow the panel 76 to be arranged generally in the area of the passenger's clavicle while panel 78 is arranged generally in the area of the passenger's sternum (see FIG. 2). Each panel has a plurality of sensor arrays. Preferably, panel 76 is provided with two sensor arrays 80, 82 while the second panel 78 is provided with three sensor arrays 84-88. The sensor panels 76, 78 are, commercially obtained from Tekscan, Inc. of South Boston, Mass. The matrix arrays are formed with a plurality of input electrodes extending in the first direction and a plurality of output electrodes extending in a different, preferably orthogonal direction to the first array. For example, with reference to FIG. 10 input electrodes 90 extend in a first direction while output electrodes 92 extend in a generally perpendicular direction. The electrodes 90, 92 are formed on thin substrates 94, 96 of a plastic material such as Mylar or suitable other substrate material. The electrode layers 90, 92 are separated by a layer 98 of pressure sensitive material, such as a pressure sensitive ink, cooperating with the input and output electrodes such that each point of intersection of the electrodes 90, 92 forms a sensor point or “sensel” which varies with the pressure applied to the sensor point.

Preferably, the no load resistance of each sensor point is relatively high (in the order of megohms) with a substantially reduced resistance (e.g., 1000 ohms) when a maximum pressure (i.e., a pressure just short of saturation) is applied to the sensor point. The resistance of each sensor point varies with changes in pressure between no load and maximum load conditions. Sensor arrangements available from Tekscan, Inc. are capable of providing force or pressure measurements at many different locations with a spatial resolution on the order of 0.05″ or less. It is preferred that the sensor arrangements are also “conformal” in the sense that, for the object being analyzed, the thinness and the flexibility of the sensor arrangements allow forces to be measured without significantly disturbing the objects providing those forces. Further details concerning the construction and operation of various suitable pressure sensor constructions may be found in U.S. Pat. Nos. 5,905,209; 5,756,904; and 5,505,072 the disclosure of which is herein incorporated by reference as if fully set forth herein.

As mentioned, the electrodes are preferably formed on a thin substrate of plastic material such as Mylar, which conforms to the outer surface of either a passenger's anatomy or a representation thereof, such as the form 60 described above. If desired, more complete anthropomorphic mannequins could be used with varying degrees of compressibility of their outer surface portions. It is important that the sensor arrangements are conformal so as to provide a generally continuous mapping of forces or pressures throughout the observed regions.

With reference to FIGS. 2, 12 and 13, the sensor panels 76, 78 are generally centrally aligned with shoulder belt 32. As shown, shoulder belt 32 is aligned along the center line 90 of panel 78 (see FIG. 12). The panels 76, 78 each have flexible connector portions 93, 95 extending away therefrom terminating in a common connector 97 for coupling to a cable 98. Cable 98, as will be seen herein, provides coupling of the sensor arrangement to an analyzer such as a digital computer which processes the sensor information and provides a screen display and other types of output indicating the results of calculations performed on the raw sensor data. If desired, cable 98 could be replaced with a radio link to provide remote telemetry capabilities.

As mentioned, the connector portions 93, 95 are preferably flexible which allows one sensor panel to be shifted relative to the other, to provide certain advantages. For example, it has been mentioned that the sensor panel 76 is arranged to provide information concerning the area of the passenger's clavicle. It has been found desirable, in some arrangements, that sensor panel 76 be provided with a reference line 102, for corresponding to the apex of the passenger's shoulder or line of contact between the belt and shoulder, as can be seen in FIG. 12. With reference to FIG. 13, reference line 102 can be aligned with a reference line 106 provided on the form 60 at the area thereon that would constitute the primary line of contact of the belt therewith so that the forward sensor array 82 is disposed thereat with the typical amount of belt webbing, e.g., approximately 50 percent, protracted from the retractor. Accordingly, the rear sensor array 80 is spaced rearwardly from this primary line of contact. However, during dynamic conditions, such as when the vehicle is turning or on rough roads or the passenger is moving, the passengers torso will typically pivot or shift away from the seat back. This causes more belt webbing to be drawn out from the retractor with consequent changes to the angle of attack the shoulder belt portion 32 assumes relative to the shoulder or clavicle and shifting of the primary line of contact rearwardly. Positioning of the sensor array 80 rearwardly thus allows it to detect load conditions between the belt and passage along the shoulder during dynamic conditions as the array 80 can sense these rearwardly shifting loads.

As shown in FIG. 13, the panel 82 is aligned with the mark 102 on the form 60 and this is at the top or the apex of the clavicle with the other panel 80 being behind the shoulder and being used to sense the forces and the mapping of the forces and pressures in areas when the torso 60 is moved forwardly by the motor as above-described.

As can be seen for example in FIG. 2 it is generally preferred that the sensor panels, and in particular the arrays be made considerably wider than the area of interest, namely the outline of the seat belt. As can be seen for example in FIG. 2, panels 76, 78 are substantially wider than shoulder belt 32. This provides a number of advantages. For example, one area of interest is the sensations experienced by a passenger at the edges of the shoulder belt, particularly the inboard edge (the left side of shoulder belt 32 as seen in FIG. 2), and a sensor panel of increased width ensures desirable monitoring at the seat belt edges. As a further advantage, the increased width of the sensor panels helps to anchor the sensor panels in their desired positions, one example of which is shown in FIG. 2. A reliable anchoring of the sensor panels is especially important during dynamic testing, i.e., a moving form in a static vehicle, a static form in a moving vehicle, and a moving form in a moving vehicle.

Pressures and forces corresponding to the loadings of the various sensor points are preferably determined by I-scan software commercially available from Tekscan, Inc. As will be seen herein, a recording of dynamic sensor output over time is stored in a “movie” form for subsequent data manipulations and other analyses. Although software manipulations can be devised to account for a shifting of the sensor panels, this imposes an added burden of the computer, and it is preferred that the sensor panels remain fixed in their relative position to a shoulder belt or other area of interest, during a test run. As mentioned, the sensor panels preferably employ a plastic backing of Mylar or other suitable material. While anchoring devices such as hook and loop fasteners could be employed between the sensor panels and the belting, this may result in unacceptable alterations of the sensor output, due for example to the added thickness and change in flexibility causing an altering of the data acquired.

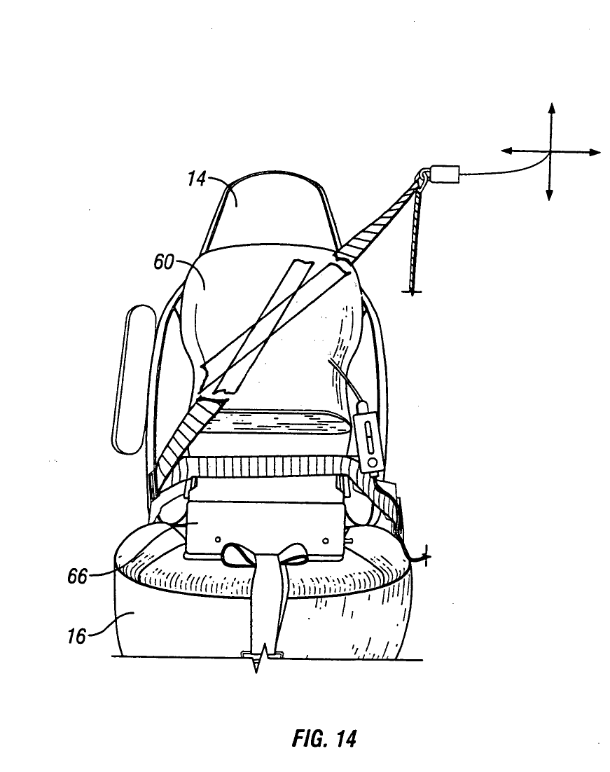

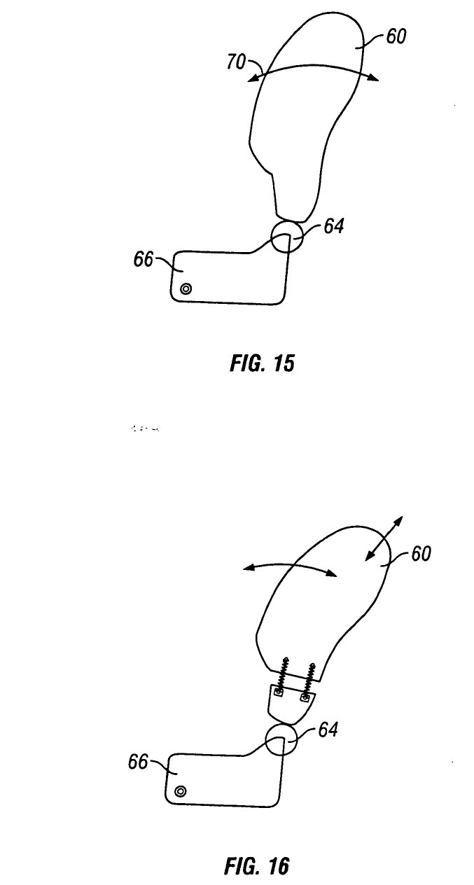

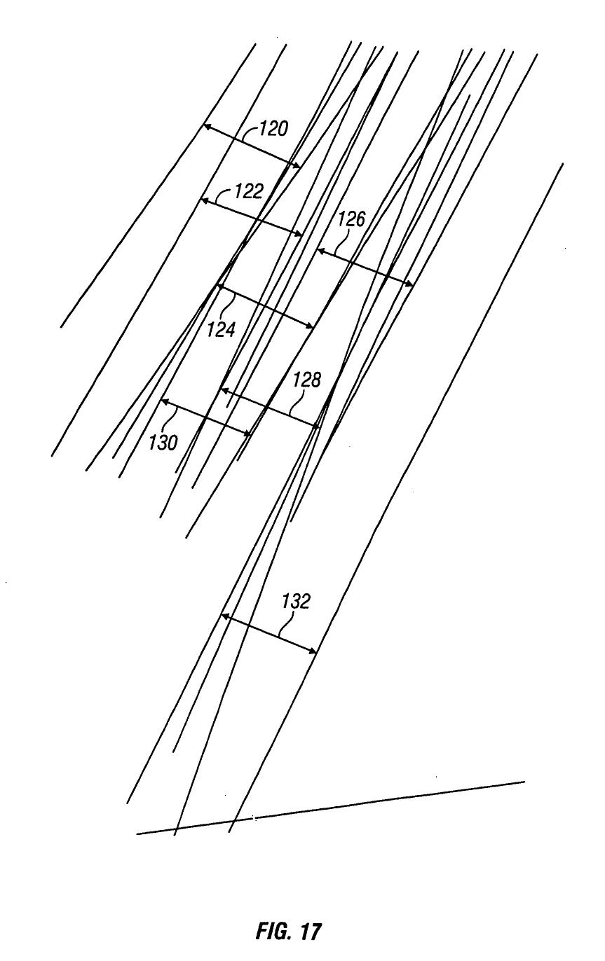

As mentioned above with regard to FIG. 14, seat belt measuring systems according to the principles of the present invention offer particularly useful improvements to a manufacture of vehicles or safety restraint systems when designing multiple vehicles in the same production year. For reasons of economy, the same restraint system may be chosen for use throughout the range of vehicles. However, it should not be expected that passengers would receive the same sensations from identical restraint systems incorporated in different vehicles. A passenger would be expected to experience different sensations, particularly arising from contact with a shoulder belt, because the belt path will shift from one vehicle to another due to different vehicle interior arrangements, i.e., different vehicle “geometries”. For example, with reference to the arrangement of FIG. 2, shoulder belt 32 is shown anchored at one end with a latching arrangement including latch 37 and buckle 110, with the shoulder belt passing over the torso area of form 60, including areas representing a passenger's sternum and clavicle. The shoulder belt 32 then passes through belt guide 40 and continues in a generally downward direction to a conventional retractor mechanism. Changing the position of guide 40, as would result from different vehicle interior geometries, would cause the path of shoulder belt 32 to shift slightly. Although the shifting may be small in terms of angular differences, test results have shown that very substantial differences in pressure force distribution and other loadings along the shoulder belt can and frequently do, result. FIG. 14 shows two different belt paths, drawn with large angular differences for purposes of illustration. Referring to FIG. 17, a grouping of practical variations in seat belt paths is illustrated. The seat belt paths are identified with reference numerals 120-132. The area illustrated in FIG. 17 corresponds generally to the area adjacent sensor array 84 in FIG. 2. A manufacturer of vehicles or safety restraint systems needs objective data from which inferences regarding passenger comfort can be analyzed. As can be seen from FIG. 17, an objective, meaningful analysis of the complex set of design considerations could be overwhelming without an orderly, detailed precision measuring afforded by the present invention. With the present invention, each of the seat belt paths illustrated in FIG. 17 could be objectively analyzed in a relatively short period of time.

Turning now to FIGS. 1, 18 and 19 the present invention makes use of conventional analyzers such as programmable computers in wide use today. FIG. 1 shows a connection of the sensor panels through connector 97 and cable 98 to a conventional digital computer 140 having an output screen 142. Further details regarding the connection of the sensor panels to the computer analyzer will be given below. Also included in the I-scan system are hardware components including an interface in the form of keyboard 141 for the computer 140 and a sensor handle which provides ready connection to the flexible connectors 93, 95 illustrated, for example, in FIG. 12. In FIG. 12, the connector 97 comprises the I-scan sensor handle. Using software commercially available from Tekscan, Inc. raw data from the sensor panels is captured by computer 140 and stored in its internal memory for later use. Preferably, the software used is commercially available from Tekscan, Inc. as part of its I-scan measuring system. Using the software, pressure and force distribution is continuously monitored and mapped in a two-dimensional array which is displayed on screen 142, or sent to another output device.

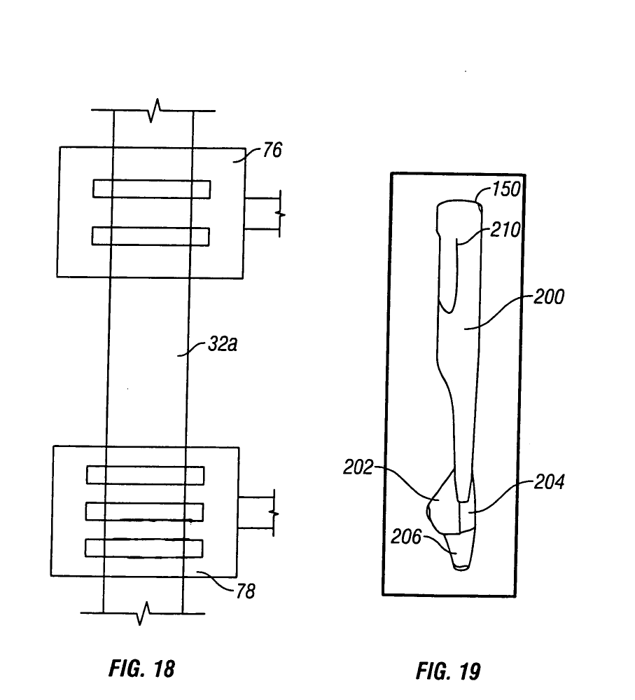

Referring to FIGS. 18-20 and initially to FIG. 18, a portion of shoulder belt 32 is shown in conjunction with sensor panels 76, 78. Sensor panels 76, 78 contain a relatively large number of sensor locations referred to as sensor points or “sensels.” The sensor panels provided from Tekscan, Inc. comprise ultra-thin flexible printed circuits having an overall thickness of approximately 0.004″ or 0.10 mm. Each pressure sensor array in each panel has a relatively large number of sensor points or “sensels.” A variety of different sensor panels can be obtained from Tekscan, Inc. with more than 2000 sensor points in each sensor array. In the preferred embodiment, the sensor arrays comprise approximately 1600 sensor points. The active sensing area of the sensor is surrounded by the substrate material that contains conductive leads. Larger or smaller numbers of sensor points could be employed, if desired.

Referring briefly to FIGS. 1 and 2, computer analyzer 140 is coupled to sensor panels 76, 78. As indicated in FIGS. 10 and 11, the sensor panels contain an array of sensors. The array has pluralities of sensor panel inputs and outputs which are coupled to respective pluralities of (computer) analyzer drive ports and (computer) analyzer inputs. The (computer) analyzer has an analyzer output. The (computer) analyzer maps data from the plurality of sensor panel outputs to an output array at the analyzer output, which corresponds generally to the configuration(s) of the sensor panel(s). In the preferred embodiment, data from the output array of the analyzer is visually displayed on the output screen of the computer monitor 140. If greater visual resolution is desired, for example, the analyzer output can be selected to display the outputs of only one of the sensor panels 76, 78. Alternatively, the outputs of both sensor panels can be “joined” in software to present a continuous display, as if the sensor panels were physically joined in one monolithic array. Further enhancements can be provided by analyzer software, For example, the resolution of the sensor points contained in sensor panel 76, 78 and the software provided by Tekscan, Inc. allows data interpolation to “fill in” areas between the sensor arrays, so as to present a continuous observed area. For example, screen output diagram 150 in FIG. 19 corresponds to a simultaneous mapping of pressure and force distribution throughout the length of the shoulder belt segment 32a, illustrated in FIG. 18. As mentioned, it is generally preferred that the software employed map the data output to a two-dimensional area corresponding to the area of observation. This provides information concerning the locations of the sensor points. Preferably, the screen output 150 is shown in color, with the different colors representing different ranges of output values from the sensor points in sensor panels 76, 78.

Referring to FIG. 19, loadings on all of the sensors within the field of interest, as indicated in FIG. 18 are simultaneously portrayed in the screen output of FIG. 19, with different sensor levels being indicated by different colors. In a preferred embodiment, the I-scan software available from Tekscan, Inc. is capable of displaying 13 possible colors, indicating 13 different pressure ranges of sensor point outputs represented by a similar number of different colors. Referring to FIG. 19, the output portion is displayed in four different color areas 200-206, respectively.

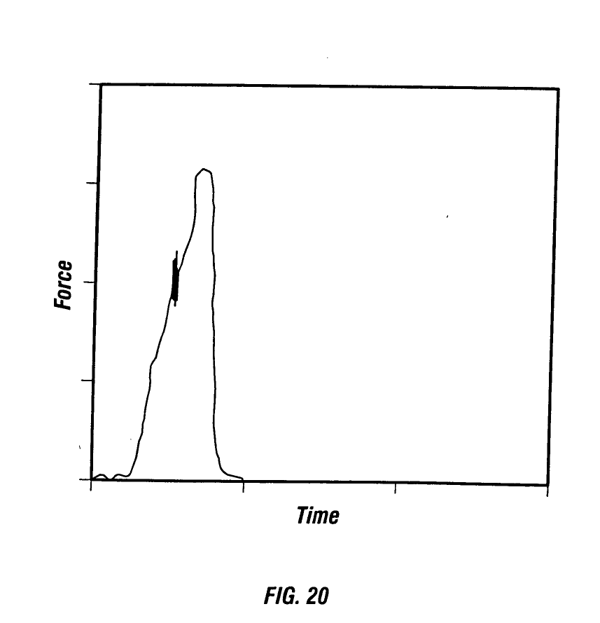

Referring to FIGS. 19 and 20, with the I-scan system provided by Tekscan, Inc. the software and sensor panels cooperate to sample pressure data as it happens in real time, present the information as a color-coded real-time display and record the information for later review and analysis. FIG. 20 shows a plot of force v. time for a test conducted according to the arrangement set out in FIGS. 1-5. The form, initially at rest, is pivotally cycled by the motorized base, according to a predetermined time cycle. During the time cycle the form is continuously moved, first in a forward direction and then in a rearward direction to regain the starting position, as indicated in FIGS. 3-5. The total force applied to the belt segment is calculated by software in the computer during the time period of the test during a forward and rearward cycle of the seat, which lasted approximately one second. A peak force value generally corresponds to the forwardmost pivoting of the form, and a “snap shot” of the sensor points during the instant of peak force is plotted as shown in FIG. 19. The snap shot shown in FIG. 19 shows the distribution of force at the instant indicated, and the mapping shown in FIG. 19 includes various color values, indicating different pressure ranges of loads on the sensor points. The large vertically elongated area prominent in FIG. 19 shows that peak loads extend throughout the upper major portion of the belt segment and centered between the inboard and outboard belt edges, while smaller loads occurred in the lower portion of the belt segment 32a and directed more toward the outboard edge thereof. At the instant in time represented in FIG. 19, all the forces imposed of the belt segment, reported by the various sensor points are calculated according to known techniques to find a center of force value. A plurality of center of force values at various sampling points during the test are also plotted in FIG. 19, and is represented in a J-shaped trace or trajectory 210. As can be readily seen from display 150, trace 210 indicates that forces throughout the test are centered in a relatively small area adjacent panel 76, in the region of the passenger's clavicle and pass from the outboard edge toward the inboard edge of the belt segment 32a as the test progresses. Trace 210 provides immediate indication that a passenger will experience highest contact forces adjacent the clavicle, and this area of belt performance should be considered for possible annoyance to a passenger. The center of force trajectory 210 is useful as an initial summary indication when going from vehicle to vehicle and helps to provide a rapid orientation of belt performance for different geometries.

The computer 140, through its drive ports, energizes the sensor panel inputs, scanning the sensor arrays in a continuously repetitive fashion to provide temporal trajectories of the sensor point loadings. Outputs of the sensor points are appear as data at the sensor panel outputs which are connected to the computer analyzer inputs. The software provided allows the user to set the number of frames to record and either the period, i.e., elapsed time between frames or frequency, i.e., number of frames per second. This allows the user to trade off data density v. speed of data processing. Various manipulations and representations of data studies have been set out herein. It must be born in mind, however, that software employed in the present invention allows the raw captured data to be subsequently used in a number of different ways, including ways which are perhaps unforeseen at the time of testing. For example, the software is able to capture and recall loadings of the various sensor points collected at relatively high frequencies during a test period. In various figures shown herein, sensor panels are shown with arrays of large numbers of sensor points, with multiple sensor arrays shown parallel and spaced from one another. The software, however, can be called upon to “ignore” such physical groupings of sensor points and can reorganize the various sensor points according to user-defined patterns established after a test has been completed. For example, the total number of sensor points can be grouped into subareas which can be isolated and analyzed after the raw data has been collected.

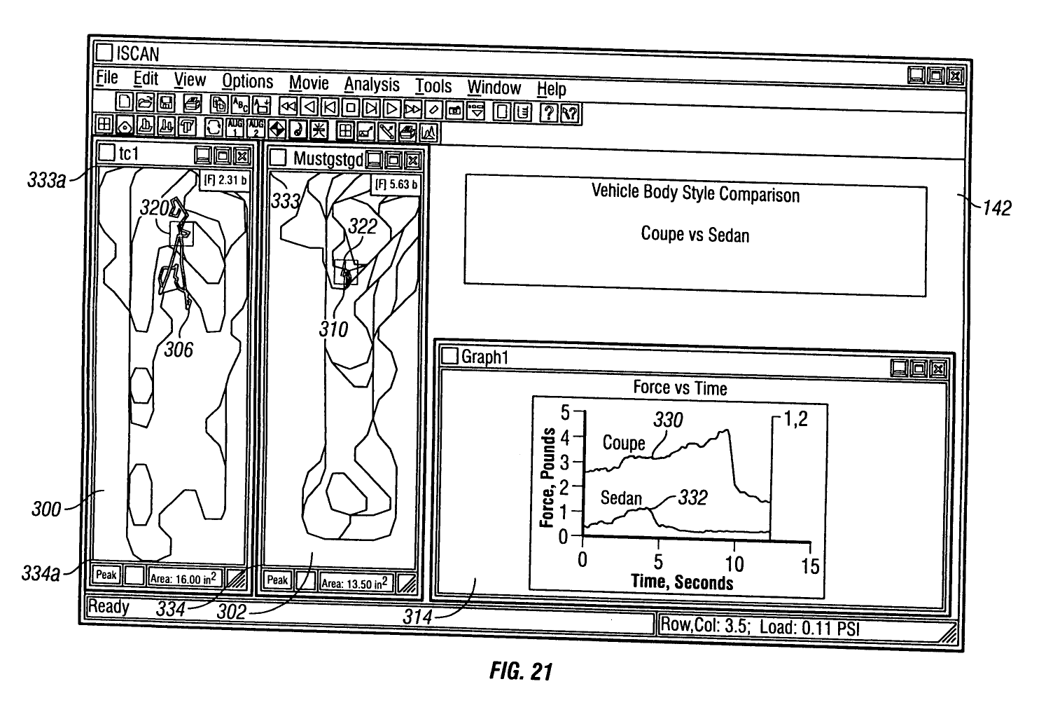

Turning now to FIGS. 21-23 screen outputs for several different test conditions are shown. In FIG. 21, the program stored and executed in computer 140 has run two tests on similar vehicles, e.g., coupe and sedan body styles of a particular vehicle make and model year. While the vehicles tested may be similar, their internal geometries change somewhat such as due to differences between the body styles. Shown on the display screen 142 of computer 140 are output screens 300, 302 corresponding to each of the vehicles tested. Each output screen reflects sensor output data for similar seat belt portions in each of the vehicles being tested. Included in each output screen is a trace or trajectory 306 of center-of-force values. In output screen 300 the trace or trajectory 306 shows that forces are centered (over time) over a relatively long generally vertical path. In output screen 302 trace 310 shows that, over the time of the test, center-of-force values are localized in a relatively small area of the shoulder belt being tested. The I-scan software also provides the ability to manipulate the raw data from the sensor points to produce an output screen 314. Portions of the two-dimensional mapping of output screens 300, 302 can be selected for further analysis. For example, in output screen 300 an area 320 has been defined for further data analysis. Similarly, area 322 has been defined in output screen 302. Ongoing average forces for the defined areas 320, 302 are presented in graph form in output screen 314, as traces 330, 332, respectively. Areas of different size and location can be readily defined by the user to provide different analyses of force v. time (see FIG. 20).

The measuring system described in this embodiment of the invention is able to provide a measurement of force, a measurement of contact area where the belt is contacting the form at the area of the shoulder or clavicle, across the chest and down to the sternum. The system also measures pressure, although typically pressure is not the best indicator of passenger comfort since the same pressure readout may be obtained despite very different force levels existing between the belt and passenger due to differences in belt contact area with the passenger. Manifestly, other systems could be employed which would have more or fewer illustrations and printouts or read outs. Once the data has been captured, it can then be displayed to provide various printouts or displays such as a graph of force versus time, the contact area, and also pressure versus time. For ease of analysis by the viewer, the illustrated measuring system may be color coded, e.g., with areas in red for the highest forces being applied and areas in blue for lesser forces and other colors for intermediate forces. Also, the output screen preferably provides an analysis of where the belt is when forces are being applied with respect to the edges of the belt. Herein, upper point 333 at the upper right hand corner of the display screen corresponds to the inboard shoulder and clavicle position on the form, the inboard shoulder and clavicle position on the display screen is at the location 333a while the lower point 334a of the screen is at the lower inboard sternum portion, and the point 334 is at the outboard sternum portion. The lines shown on the left hand portion of the display relate to the inboard edge of the belt with a top portion of the lines illustrating belt loading on the upper or clavicle area and with the lower outboard portion of the belt loading being displayed in the lower left hand corner of the screen shown in FIG. 21. The belt loading at the upper outboard clavicle area is shown in the upper portion of this screen 300 adjacent the upper right hand corner of the screen. The belt loading along the lower outboard sternum is shown at the lower portion of the screen 300 adjacent the lower right hand corner of the screen 300.

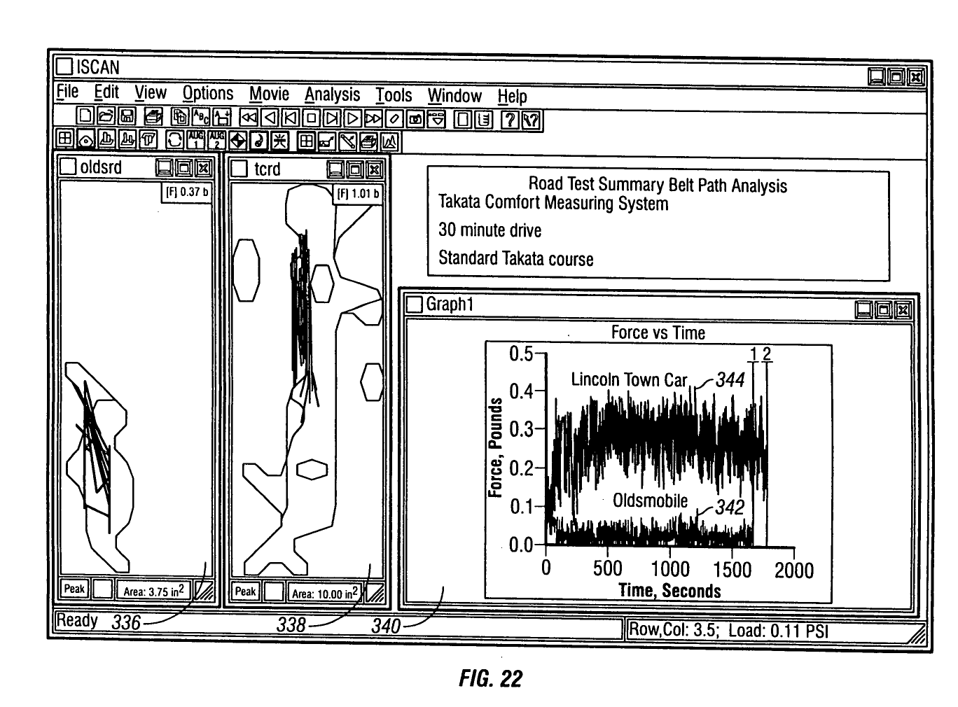

In FIG. 22, output screens 336, 338 show road test results for two different vehicles of generally the same size. An output screen 340 contains traces 342, 344 of force v. time corresponding to the output screens 336, 338, respectively. For example, the screen 336 shows a vehicle identified as an Oldsmobile in FIG. 22 as having the force versus time graphically illustrated as being in the lower lefthand portion of the screen 336 which means that the forces are applied closer to the sternum. Herein the magnitude of the forces at the sternum indicated by the graph line 342 show lesser amounts of force on the form than the forces for the other vehicle which is identified as a Lincoln Town Car. By way of example only, force readouts 344 range between approximately 2 to 4. In the illustration on the screen 338 for the Lincoln Town Car, the analysis shows by the heavier dark line portion 338a that the forces being applied are quite heavy up toward the clavicle area and closer to the inboard edge of the belt. Thus there is a need for the belt position change so that the belt is flatter across the chest and upper portion of the form to reduce the concentration of forces along the upper chest area and toward the inboard edge of the belt. As is apparent, the particular seat belt system chosen for use in conjunction with the particular vehicle geometry provided by the Oldsmobile is more advantageous than that used with the geometry of the Town Car from a passenger comfort standpoint.

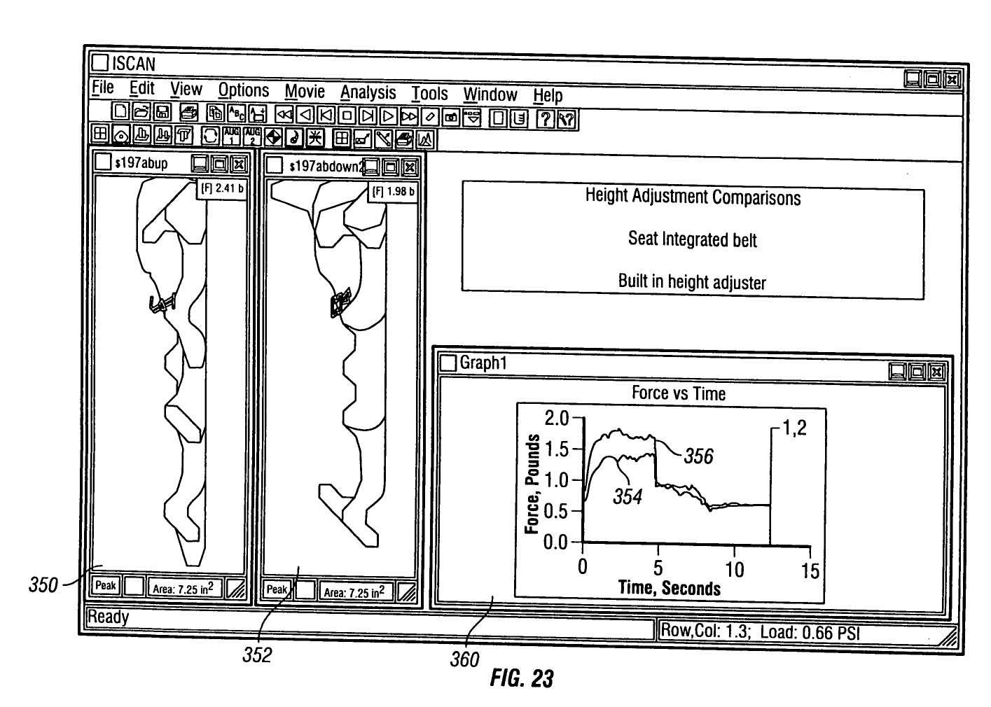

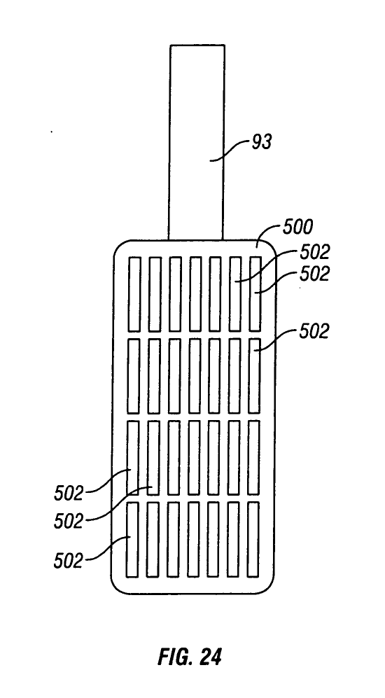

In FIG. 23, two tests are shown for a vehicle having an adjustment in the belt loop guide. As indicated in FIG. 2, the belt loop guide 40 can be adjusted up and down using laboratory test equipment. As an experiment, a range of vertical adjustment is provided for the vehicle of FIG. 23 for a belt loop guide supported from the seat back, and having a vertical range of adjustment. In FIG. 23, output screens 350, 352 are shown for the height adjuster in lower and upper positions, respectively. The two-dimensional mappings of output screens 350, 352 correspond to traces 354, 356 of force v. time in output screen 360.

As can be seen from FIGS. 21-23, measuring systems according to principles of the present invention can be employed to provide a wide variety of objective analyses using data which is quickly and easily obtained both in a laboratory setting as well as in real-world road tests. With the present invention, objective evaluations of belt path geometries and specific belt contact points can be analyzed in depth in a complex dynamic environment. With the present invention, objective analyses can now be obtained which provide metrics of passenger comfort in a particular safety restraint system. The measuring system of the present invention can be employed to indicate actual belt contact points as well as distributed forces and pressures. System software captures raw sensor data which can be replayed at a later time or manipulated in new ways as ongoing research is conducted. With the present invention, an objective set of data can be obtained for later determination of the complex effects of changes in vehicle geometry, seats, belt path guides, intermediate guides and the effect of any interference with vehicle trim. In addition, real time output is available while conducting a test.

With reference to FIGS. 6-9, measuring systems according to the present invention can be readily and economically employed in a number of different types of restraint systems. For example, in FIG. 6 a three-point restraint system is illustrated with a lap belt 370 monitored by two sensor panels 372, 374 and a shoulder belt 380 monitored by sensor panels 382, 384. The sensor panels are connected to a computer or controller 386, in the manner described above. With the arrangement of FIG. 6, more detailed information can be obtained with respect to forces in the lap portion and interactions with the upper torso can be analyzed. The form has been omitted in FIG. 6, as well as FIG. 7-9, for purposes of clarity.

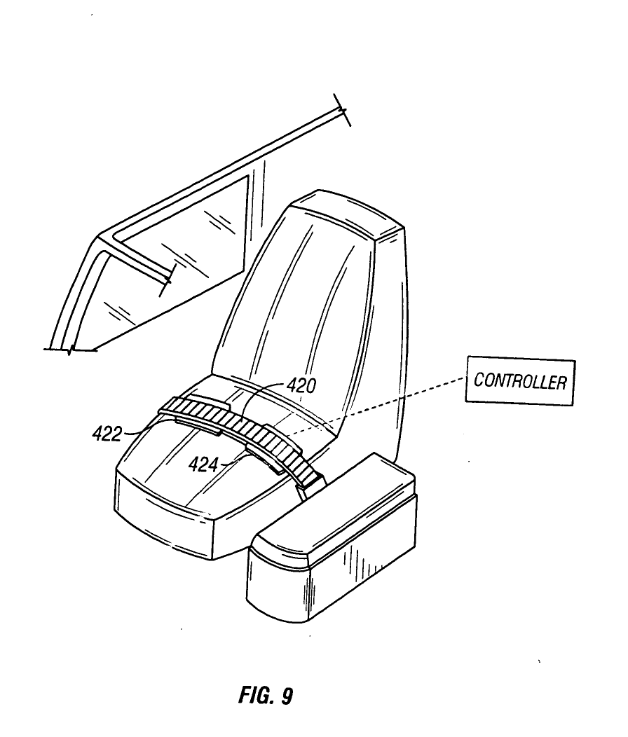

Turning now to FIG. 7, a safety restraint system has a lap belt 390 monitored by panels 392, 394 and a shoulder belt 400 monitored by a plurality of sensor arrays carried on a common, flexible substrate 402. FIG. 24 shows a similar sensor system. In FIG. 7 the substrate 402 is shown having a width more closely resembling that of the seat belt than the arrangement illustrated in FIG. 2, for example where panels having greater enlarged widths are shown. In FIG. 8, lap and shoulder belts 410, 412 are monitored by pluralities of sensor arrays carried on single flexible substrates 414, 416, respectively. In FIG. 9, a vehicle restraint system including a lap belt 420 is monitored by sensor panels 422, 424.

Other types of restraint systems can be readily analyzed with measurement systems according to principles of the present invention. For example, X-shaped belt systems of the types used in professional race cars and increasingly popular in passenger vehicles can be readily analyzed without requiring vehicle modifications which would perturb observed readings. Restraint systems in other types of vehicles, such as aircraft, land-based test vehicles, construction vehicles and the like can also be analyzed with systems according to the present invention. Further, the system is described in accordance with the illustrated embodiment in which a form is used with system; but manifestly the system may be used with a human passenger rather than a form.

The drawings and the foregoing descriptions are not intended to represent the only forms of the invention in regard to the details of its construction and manner of operation. Changes in form and in the proportion of parts, as well as the substitution of equivalents, are contemplated as circumstances may suggest or render expedient; and although specific terms have been employed, they are intended in a generic and descriptive sense only and not for the purposes of limitation, the scope of the invention being delineated by the following claims.

What is claimed is:

1. A seat belt comfort measuring system for vehicles, comprising:
sensors for measuring loads being applied along several portions of a belt path along a passenger's body or torso form and providing output signals representative of the loads being applied; and
an analyzer coupled to the sensors for receiving the output signals, recording the measured force and analyzing the measured loads to allow evaluation of the comfort of the seat belt system.

2. A seat belt comfort measuring system in accordance with claim 1 comprising a display for providing a visual display of the loads being applied by the seat belt to the passenger's body or form.

3. A seat belt comfort measuring system in accordance with claim 1 wherein the sensors comprise a flexible panel conformable to the passenger's body or form and against which the seat belt applies force.

4. A seat belt comfort measuring system in accordance with claim 3 wherein the flexible panel allows measuring of the seat belt loads along the edges of the seat belts.

5. A seat belt comfort measuring system in accordance with claim 3 wherein the flexible panel is split into a clavicle portion and a sternum portion for measuring loads at corresponding locations on the passenger's body.

6. A seat belt comfort measuring system in accordance with claim 1 comprising a seat and means for inclining the seat forward and rearwardly through inclined positions while measuring force loads being applied as the force loads of the seat belt changes on the passenger's body or form during the inclination of the seat.

7. A seat belt comfort measuring system in accordance with claim 1 comprising sensors positionable along the shoulder area of the passenger or form for measuring the force loads being applied by the seat belt to the shoulder area.

8. A seat belt comfort measuring system in accordance with claim 1 comprising sensors at four measuring zones including a back clavicle zone, a chest zone, a front clavicle zone and a sternum zone.

9. A seat belt comfort measuring system in accordance with claim 1 wherein the analyzer comprises a dynamic display for showing the mapping of loads along the belt edges and along the belt at different locations along the form or body of the passenger as the measuring is proceeding for a period of time.

10. A seat belt comfort measuring system in accordance with claim 1 wherein the analyzer provides a dynamic mapping of the pressure being applied by the seat belt along the form or body and provides graphs of the force pressure.

11. A seat belt comfort measuring system in accordance with claim 1 comprising a seat having a seat back and a seat bottom, a guide loop through which the belt passes onto the body of the passenger and a positionable support for the guide loop to position the guide loop at locations and to provide the seat back at an angle that will be representative of the location and the angle of the belt for a particular vehicle geometry.

12. A seat belt comfort measuring system in accordance with claim 1 comprising an output display system coupled to the analyzer for providing a visual video of the outputs of the sensors and to provide a mapping system display of the forces being applied.

13. A seat belt comfort measuring system in accordance with claim 12 wherein the output display system displays in color values the different amounts of force being sensed along different portions of the passenger's body or form.

14. A method of measuring the comfort of a seat belt system using sensors for measuring force being applied and providing a visual output of loading along a form or passenger's body, the method comprising:
positioning sensors along the path of the seat belt along the form or along the passenger's body while in a vehicle seat;
providing an analyzer for recording and analyzing the measured forces; and
displaying a visual output derived from the measured forces by the analyzer to allow evaluation of the comfort of the seat belt system.

15. A method in accordance with claim 14 comprising:
displaying a dynamic mapping of the pressure being applied along the edges and other portions of the seat belt as the seat belt system is being tested.

16. A method in accordance with claim 14 wherein the sensor positioning comprises positioning a first panel of sensors along a clavicle area of the body and a separate second panel of sensors along a sternum area of the form or body.

17. A method in accordance with claim 14 comprising:
moving the seat back and measuring the changes and force being applied by the seat belt to the form or passenger's body during the movement of the seat back.

18. A method in accordance with claim 14 comprising:
positioning the form in a vehicle representative of the passenger's torso, including the passenger's clavicle and sternum and measuring the force while the vehicle is being moved along various different terrain so as to provide a dynamic output of the comfort of the seat belt system while the vehicle is moving.

19. A method in accordance with claim 18 comprising:
repositioning a belt guide loop to a position corresponding to a position for the seat belt guide loop in a vehicle to present the belt to the form at the angle at which it would be presented when a passenger is located on the seat for a particular vehicle geometry.

20. A method in accordance with claim 14 comprising:
locating the retractors at the positions they would be in the vehicle and locating the anchor point at a position corresponding to a vehicles anchoring position and then testing the system with the seat belt being presented as for a particular vehicle's geometry.

21. A method in accordance with claim 20 comprising:
measuring the force at a location corresponding to the passenger's clavicle, measuring the force at a position corresponding to the belt at the passenger's chest and measuring the forces corresponding to the position of the passenger's sternum.

22. A method in accordance with claim 14 comprising:
providing a dynamic graphing showing a force against time graph for the seat belt system wherein the test and graph provide a visual mapping of the pressure being applied to the belt to locations corresponding to the belt on the passenger's torso in a dynamic mode.

23. A method in accordance with claim 22 comprising:
visually displaying the forces and dynamic loading along the edges and other locations of the belt to show a peak force area.

24. A seat belt comfort testing system comprising:
a passenger seat;
a seat belt system having a retractor and a seat belt;
movable anchoring points for the seat belt and for movement to positions representative of the anchoring points for the seat belts in a vehicle;
a form having an outer surface representing a person's chest area and shoulder area;
sensors associated with the seat belt to measure force applied by the seat belt to the chest area and shoulder area and to provide signals representative of force being applied by the seat belt to the chest and shoulder areas; and
an analyzer coupled to the sensors to record and to analyze the signals received from the sensors.

25. A seat belt comfort testing system in accordance with claim 24 wherein the form sensors are moveable and portable and can be positioned in the vehicle and coupled to an analyzer to make and record signals from the sensors while the vehicle is in motion.

26. A seat belt comfort testing system in accordance with claim 24 comprising a display associated with said analyzer to provide a visual display and dynamic mapping forces of the signal outputs to provide a visual display corresponding to force or pressure at locations along the chest and shoulder areas.

27. A seat belt comfort measuring system in accordance with claim 24 comprising a motor drive connected to the seat back to move the seat back in a cyclic manner to provide comfort readings simulating the movement of a passenger in a seat.

28. A seat belt comfort system in accordance with claim 24 comprising a moveably positioned guide loop moveable to emulate a variety of vehicle positions and for guiding the shoulder belt of the seat belt system to the shoulder area of the form.

29. A seat belt system in accordance with claim 24 wherein the sensors comprise a flexible sensor panel generally conformable to the outer surface of the form.

30. A seat belt comfort measuring system in accordance with claim 24 wherein the sensors are positioned to measure force at the upper clavicle, the back of the clavicle, the chest area and the sternum.

31. A seat belt measuring system for measuring loadings including contact area or pressure or force distribution imposed on a passenger restrained by a safety restraint belt, the seat belt measuring system comprising:
a form having an outer surface, representing a passenger's torso, including the passenger's clavicle and sternum;
a flexible sensor panel system generally conformable to the outer surface of the form;
said sensor panel having at least one sensor array including a plurality of sensor panel inputs and a plurality of sensor panel outputs, cooperating to form a plurality of sensor points arranged on a flexible backing sheet in a two-dimensional array, each sensor point having a sensor point output varying according to the force imposed on the sensor, appearing at least one of said plurality of sensor panel outputs; and
an analyzer coupled to said flexible sensor panel which records, processes and evaluates signals emitted from said plurality of sensor panel outputs.

32. The system of claim 31 wherein said sensor panel system further comprises a second flexible sensor panel spaced from said one flexible sensor panel.

33. The system of claim 32 wherein said second flexible panel is substantially independently movable with respect to said one flexible panel.

34. The system according to claim 31 wherein said form includes a base movably mounting said form, and
a motor drive for pivotally moving said form in forward and backward directions.

35. The system according to claim 34 wherein said base further comprises a motor drive for moving said form in upward and downward directions.

36. The system according to claim 31 wherein said form includes an upper surface representing a passenger's clavicle, said form including a reference line extending across the width of the form and first flexible sensor panel including a reference line for ready visual alignment with the reference line on said form, to align said sensor panel with respect to said form.

37. The system according to claim 36 wherein the reference line on said flexible sensor panel is aligned with a sensor array carried on said flexible sensor panel.

38. The system according to claim 31 further comprising a seat having a seat back and a seat bottom, a guide loop for supporting said seat belt, and a guide loop mount for movably mounting said guide loop with respect to said seat so as to provide emulation of a variety of vehicle interiors.

39. The system of claim 31 wherein said analyzer comprises a computer.

40. The system according to claim 39 wherein said computer includes a plurality of analyzer inputs coupled to said plurality of sensor panel outputs, a plurality of drive ports coupled to said plurality of sensor panel inputs, and an analyzer output mapping said plurality of sensor panel outputs to an output array corresponding generally to the configuration of said sensor array.

41. The system according to claim 40 wherein said computer further includes a video system, with said output array viewable on the video system to substantially simultaneously display sensor point outputs of said plurality of sensor points.

42. The system according to claim 41 wherein the output array viewable on the video system has color values corresponding to the amount of force imposed on said sensor points.

43. A method of measuring loadings including contact area or pressure or force distribution imposed on a passenger by a safety restraint belt, comprising the steps of:
providing a form having an outer surface, representative of a passenger's torso, including the passenger's clavicle and sternum;
continuously rounding said form throughout the contact area with the belt;
providing a flexible sensor panel conformable to the outer surface of the form;
providing the sensor panel with a plurality of sensor points, a plurality of sensor panel inputs and a plurality of sensor panel outputs, corresponding to a plurality of sensor points arranged in a two-dimensional array, each sensor point having an output with data varying according to the loading imposed on the sensor point;
providing a programmable computer having a plurality of inputs for coupling to the sensor point outputs, a plurality of drive ports for coupling to the plurality of sensor panel inputs and a video output;
mapping data from said sensor point outputs with said computer into an output array corresponding generally to said sensor array;
displaying said output array on the video output of the computer; and
repetitively scanning said plurality of sensor point outputs with said computer to determine changes in sensor point loadings and updating said video display accordingly, whereby ongoing changes in loadings imposed on said flexible sensor panels is continuously displayed on said video output.

44. The method of claim 43 further comprising the steps of:
providing a base;
pivotally mounting the form to the base; and
pivoting said form with respect to said base.

45. The method according to claim 43 comprising the steps of:
providing a seat having a seat back and a seat bottom;
providing a guide loop;
movably positioning the guide loop adjacent the seat back; and
passing the belt through the guide loop with the guide loop supporting the belt.

46. The method of claim 45 further comprising the step of providing a movable mounting for the guide loop for movement with respect to said seat back.
